(19) United States
(12) Patent Application Publication
(10) Pub. No.: US 2015/0147437 A1
(43) Pub. Date: May 28, 2015

(54) METHOD FOR PREPARING CHEESES WITH IMPROVED AROMA

(71) Applicant: DuPont Nutrition Biosciences ApS, Copenhagen (DK)

(72) Inventors: Elise Manoury, Chatellerault (FR); Véronique Laffitte, Dange-Saint-Romain (FR)

(21) Appl. No.: 14/411,902

(22) PCT Filed: Jul. 5, 2013
(86) PCT No.: PCT/EP2013/001982

§ 371 Date: Dec. 29, 2014

(30) Foreign Application Priority Data
Jul. 6, 2012 (EP) 12305813.3

(51) Int. Cl. A23C 19/032; A23C 19/068

(52) U.S. Cl. CPC A23C 19/032; A23C 19/0688; A23V 2002/00; A23Y 2220/77
USPC 426/40; 426/582; 435/252.4

(57) ABSTRACT

The present invention provides a method for preparing fermented milk products, especially cheeses such as foil-ripened cheeses, wherein said cheeses have a sulphur aroma.

### FIELD OF THE INVENTION

The present invention provides a method for preparing fermented milk products, especially cheeses such as foil-ripened cheeses, with improved aroma.

### BACKGROUND OF THE INVENTION

Cheeses can be classified, among other criteria, by the type of ripening step they have been subjected to. One can distinguish smear-ripened cheeses (or smeared cheeses) on the one hand, and foil-ripened cheeses on the other hand.

Smear-ripened cheeses are cheeses that generally have a rind comprising microorganisms involved in the cheese ripening, especially for the cheese flavour, whereas foil-ripened cheeses do not have any rind (no or a limited growth of microorganisms on its surface).

Nowadays the foil-ripened cheese segment increases significantly as it presents many advantages compared to smear-ripened cheeses, both for the cheese producers and the final consumers. Indeed, the non-rind technology for producers allows the reduction of cost due to labor intensive smearing technology. It also presents the advantage to increase the yield by losing less water along wrapped ripening and to avoid risks to spoil the cheese during ripening manipulations and also all along the cheese shelf-life. The ripening stages are better mastered with the non-rind technology, enabling producers to get better standardisation and reproducibility of their cheeses productions. For the consumers, the appearance of the cheese is more attractive and convenient (less sticky, easier to handle). This advantage even opens to a worldwide market where the rind of the cheese is no more wanted. But the consumers still want cheeses with typical aromas.

It is well recognized that this current foil-ripened cheese technology deeply suffers from a lack of flavours, such as the sulphur aroma. Usually, the production of sulphur compounds in smear-ripened cheeses occurs mainly via the development of Brevibacteria on the surface of the cheese. However, due its strict aerobic growth conditions, it is difficult to use Brevibacteria in order to produce flavours in the cheese body.

Therefore, there is an unmet need in the art for methods for obtaining cheese, in particular foil-ripened cheese, having a satisfactory aroma.

### SUMMARY OF THE INVENTION

The inventors have discovered that strains belonging to the Lactobacillus sakei species were able, when inoculated in milk, to produce volatile sulphur compounds during the fermentation and/or ripening step(s) of a process to produce a fermented milk product and therefore to develop sulphur aroma, preferably sulphur egg aroma in the resulting fermented milk product.

Hence the present invention relates to the use of at least one strain of Lactobacillus sakei for producing volatile sulphur compounds in fermented milk products.

The invention also relates to the use of at least one strain of Lactobacillus sakei for developing sulphur aroma, preferably sulphur egg aroma, in fermented milk products.

The invention further relates to a method for producing volatile sulphur compounds in fermented milk products, comprising the step of inoculating milk with at least one strain of Lactobacillus sakei.

The invention also relates to a method for making a fermented milk product having a sulphur aroma, preferably sulphur egg aroma, comprising the step of inoculating milk with at least one strain of Lactobacillus sakei.

The invention also relates to a fermented milk product, such as a cheese, preferably a hard or semi-hard cheese, even more preferably a semi-hard, foil-ripened cheese obtainable by the method as described above.

The invention also relates to a fermented milk product, such as a cheese, preferably a hard or semi-hard cheese, even more preferably a semi-hard, foil-ripened cheese, comprising at least one strain of Lactobacillus sakei.

### DETAILED DESCRIPTION OF THE INVENTION

The present invention relates to the use of at least one strain of Lactobacillus sakei for producing volatile sulphur compounds in fermented milk products.

As used herein, the expression “volatile sulphur compounds” refers to any compounds responsible for a sulphur aroma such as thiols (e.g. hydrogen sulphide, methanethiol . . . ), sulphides (e.g. dimethylsulphide dimethyldisulphide, dimethyltrisulphide, dimethylquadrisulfide . . . ), thioethers (e.g. 2,4-dithiapentane, 3,4-ditiahexane, 2,4,5-trithiahexane, 3(methyl)2,4-dithiapentane . . . ), S-methylthioesters (e.g. s-methylthioacetate, s-methylthiopropionate, s-methylthiobutyrate, s-methylthioisobutyrate, s-methylthioisovalerate, s-methylhexanoate . . . ) and aldehydes (e.g. methional, methylthioacetaldehyde . . . ).

In a particular embodiment, the present invention relates to the use of at least one strain of Lactobacillus sakei for producing hydrogen sulphide in fermented milk products, preferably in cheeses. In a particular embodiment, the concentration of hydrogen sulphide produced in fermented milk products, wherein at least one strain of Lactobacillus sakei is used according to the different embodiments of the invention, is increased of a factor of at least 3, of at least 4, of at least 5, of at least 6, of at least 7, of at least 8, of at least 9, of at least 10 or of at least 15, compared to similar fermented products obtained in the same conditions in the absence of Lactobacillus sakei. In a particular embodiment, the concentration of hydrogen sulphide is determined, as described in the examples, at least 2 weeks after that the milk has been inoculated with at least one strain of Lactobacillus sakei according to the different embodiments of the invention, under conditions enabling fermentation and ripening.

The invention also relates to the use of at least one strain of Lactobacillus sakei for developing sulphur aroma, preferably sulphur egg aroma, in fermented milk products.

Sulphur egg aroma can be quantified by a sensory assessment test, by a panel of well-trained assessors, using a seven-point scale (from 0 i.e. level of non-perception of the aroma to 6 i.e. level of very high perception of the sulphur aroma).

Typically, the use of at least one strain of Lactobacillus sakei according to the invention enables to develop sulphur aroma with a score of at least 1.1, preferably at least 1.5, even more preferably at least 2, even more preferably at least 2.5, even more preferably at least 3, when measured on a seven-point scale, in fermented milk products

Typically, the use of at least one strain of Lactobacillus sakei according to the invention enables to increase the sulphur egg aroma score by at least 0.25 point, preferably at least preferably at least 0.5, preferably at least one point, preferably at least 2 points, even more preferably at least 3 points, when measured on a seven-point scale, in fermented milk products compared to similar fermented milk products obtained in the absence of Lactobacillus sakei.

The invention further relates to a method for producing volatile sulphur compounds in fermented milk products, comprising the step of inoculating milk with at least one strain of Lactobacillus sakei.

The invention also relates to a method for making a fermented milk product having a sulphur aroma, preferably a sulphur egg aroma, comprising the step of inoculating milk with at least one strain of Lactobacillus sakei.

Lactobacillus sakei is a Gram-positive microaerophilic bacterium commonly found living on fresh meat and fish. This bacterium is valuable in the fermentation of meat products and exhibits properties that allow for better preservation and storage of fresh meats and fish. It is the predominant bacteria used for meat fermentation especially in Europe as acidification and/or preservation agents. It has now surprisingly been found that Lactobacillus sakei is able to adapt and grow on milk, a medium that is totally different from meat or fish. The bacteria can be used mainly as aromatisation agent, especially to develop sulphur aroma of fermented milk products such as cheeses.

The strain of Lactobacillus sakei according to the invention can be any strain of Lactobacillus sakei.

In one embodiment, the strain of Lactobacillus sakei is selected from the group consisting of:
Lactobacillus sakei strain deposited at the CNCM by Danisco France SAS on 25 Apr. 2007 under the number CNCM I-3750;
Lactobacillus sakei strain deposited at the CNCM by Rhodia Food SAS on 23 May 2000 under the number CNCM I-2479;
and mixtures thereof

Preferably, the strain of Lactobacillus sakei is Lactobacillus sakei strain deposited at the CNCM by Danisco France SAS on 25 Apr. 2007 under the number CNCM I-3750.

Typically, the Lactobacillus sakei strain is added at a rate of 10⁵ to 10¹² CFU (or colony forming units) per litre of milk, preferably from 10⁵ to 10¹¹ CFU per litre of milk, preferably from 10⁶ to 10¹⁰ CFU per litre of milk, preferably from 10⁷ to 10⁹ CFU per litre of milk, preferably approximately 10⁸ or 10⁹ CFU per litre of milk.

According to the present invention, the strain of Lactobacillus sakei can be used alone or in combination with other microorganisms.

When used in combination, said other microorganisms are typically selected from bacteria, fungi, molds, yeasts, archaea, protists or any mixture thereof.

In one embodiment, said fungi/molds are selected from Penicillium spp, Geotrichum spp, Lecanicillium spp, and Trichothecium spp.

In one embodiment, said yeasts are selected from Kluyveromyces spp, Debaryomyces spp, Yarrowia spp, Pichia spp, Williopsis spp, and Saccharomyces spp.

In a preferred embodiment, said microorganisms are bacteria from any genus or species. Preferred bacteria according to the invention are lactic acid bacteria, Bacillus, Staphylococcus such as Staphylococcus vitulinus, and coryneform bacteria such as for example Arthrobacter spp, Corynebacterium spp, Brevibacterium spp such as Brevibacterium casei, Brevibacterium linens or/and Brevibacterium aurantiacum.

In a particular embodiment, the strain of Lactobacillus sakei is used in combination with a strain Staphylococcus such as Staphylococcus vitulinus and/or with a strain Brevibacterium such as Brevibacterium casei, Brevibacterium linens or/and Brevibacterium aurantiacum.

In a particular embodiment the strain of Lactobacillus sakei is used in combination with at least a strain of Staphylococcus vitulinus, preferably the strain Staphylococcus vitulinus deposited at the CNCM by Danisco France SAS on 25 Apr. 2007 under the number CNCM I-3751. Advantageously, the sulphur aroma developed by these combinations is even greater than the sulphur aroma developed by the strain of Lactobacillus sakei alone.

Typically, the Staphylococcus vitulinus strain, is added at a rate of 10⁵ to 10¹² CFU (or colony forming units) per litre of milk, preferably from 10⁵ to 10¹¹ CFU per litre of milk, preferably from 10⁶ to 10¹⁰ CFU per litre of milk, preferably from 10⁷ to 10⁹ CFU per litre of milk, preferably approximately 10⁸ or 10⁹ CFU per litre of milk.

Therefore, the invention also relates to a bacterial composition comprising at least one strain of Lactobacillus sakei and at least one other strain selected from the group consisting of
a strain of Staphylococcus, such as a strain of Staphylococcus vitulinus, preferably the strain Staphylococcus vitulinus deposited at the CNCM by Danisco France SAS on 25 Apr. 2007 under the number CNCM I-3751,
a strain of Brevibacterium, such as a strain Brevibacterium casei, Brevibacterium linens or Brevibacterium aurantiacum.

In a particular embodiment, the strain of Lactobacillus sakei is used in combination with at least one lactic acid bacteria (LAB). In a particular embodiment, the strain of Lactobacillus sakei, alone or in combination with at least one strain of Staphylococcus and/or at least one strain of Brevibacterium as described herein, is used in combination with at least one lactic acid bacteria (LAB). According to the invention, the term “lactic acid bacteria” includes any bacteria capable of producing, as the major metabolic end product of carbohydrate fermentation, lactic acid or at least one of its derivatives (including, but not limited to, propionic acid). The term is therefore intended to include propionic acid bacteria (PAB), which produce propionic acid as a carbohydrate fermentation product. Preferably the bacteria in the present invention are lactic acid bacteria which are generally recognised as safe for animal or human consumption (e.g. bacteria that are GRAS approved, bacteria that are included in the most updated list of QPS microorganisms . . . ).

Suitable lactic acid bacteria may be selected from the genus Lactococcus, Lactobacillus, Leuconostoc, Bifidobacterium, Carnobacteriurn, Enterococcus, Propionibacterium, Pediococcus, Streptococcus and mixtures thereof. Typically, the microorganisms are probiotics or DFM (Direct Fed Microbials). According to the invention “probiotics” or “DFMs” means live microorganisms which when administered in adequate amounts confer a health benefit to the host, the host being a human in the case of probiotics and an animal in the case of DFMs.

These LAB can be selected from the group comprising the following species and their subspecies Bifidobacterium bifidum, Bifidobacterium animalis (e.g. Bifidobacterium animalis lactis), Bifidobacterium longum, Bifidobacterium breve, Lactobacillus reuteri, Lactobacillus acidophilus, Lactobacillus casei, Lactobacillus plantarum, Lactobacillus delbrueckii (e.g. Lactobacillus delbrueckii bulgaricus), Lactobacillus rhamnosus, Lactococcus lactis, Lactobacillus pentosus, Lactobacillus buchneri, Lactobacillus brevis, Pediococcus pentosaceus, Pediococcus acidilactici, Pediococcus parvulus, Propionibacterium freudenreichii, Propionibacterium jensenii and Streptococcus salivarius (e.g. Streptococcus salivarius thermophilus).

In a preferred embodiment of the invention, the strain of Lactobacillus sakei is used in combination with at least one acidifying lactic acid bacteria. In a particular embodiment of the invention, the strain of Lactobacillus sakei, alone or in combination with at least one strain of Staphylococcus and/or at least one strain of Brevibacterium as described herein, is used in combination with at least one acidifying lactic acid bacteria.

Without wishing to be bound by theory, the inventors believe that, during the fermentation of milk, there exists a symbiosis between acidifying lactic acid bacteria present in the starter culture (whose role is mainly to decrease the pH and/or modifying the protein matrix of the milk) and the Lactobacillus sakei (whose role is mainly to increase the development of sulphur aroma).

As used herein, the expression “acidifying lactic acid bacteria” has its general meaning in the art. The acidifying properties of the lactic acid bacteria can be described by the rate of acidification, using the following descriptor calculated by CINAC: Slope between pH6 and pH5 (pH unit/min (pHu/min)). In the test conditions, the fermentation is done in 100 ml of half-skimmed UHT milk (Le Petit Vendéen®) inoculated with the lactic acid bacteria to be tested at a rate of 5 to 10 g/100 l, then incubated at 32° C. (in a water bath). The pH is continuously monitored using a CINAC apparatus. Under these operating conditions, it is estimated that this variable is characteristic of the lactic acid bacteria rather than the inoculation rate. Several groups of lactic acid bacteria can be distinguished:
the lactic acid bacteria with so-called slow acidification, the Slope pH6-pH5 of which is at least 0.0010 pHu/min,
the lactic acid bacteria with so-called medium acidification, the Slope pH6-pH5 of which is between 0.0050 and 0.0075 pHu/min,
and the lactic acid bacteria with so-called rapid acidification the Slope pH6-pH5 of which is greater than 0.0075 pHu/min.

The term “acidifying lactic acid bacteria” encompass the lactic acid bacteria of the 3 above mentioned groups (i.e. slow, medium and/or rapid acidifying lactic acid bacteria). The skilled person will be able to choose the desired acidifying lactic acid bacteria depending on the technology.

In a particular embodiment, the strain of Lactobacillus sakei is used in combination with at least one acidifying lactic acid bacteria belonging to the Lactobacillus genus. Some particular examples are Lactobacillus acidophilus strains such as Lactobacillus acidophilus deposited at the CNCM (Collection Nationale de Cultures de Microorganismes, Institut Pasteur, 25 rue du Docteur Roux, F-75724 Paris Cedex 15), by Danisco France SAS on 3 Jul. 2007 under the number CNCM I-3784, or Lactobacillus paracasei strains.

In a particular embodiment, the strain of Lactobacillus sakei is used in combination with at least one acidifying lactic acid bacteria belonging to the Lactococcus genus.

In a particular embodiment, the strain of Lactobacillus sakei is used in combination with at least one acidifying lactic acid bacteria belonging to the Lactococcus lactis species, preferably Lactococcus lactis subsp lactis and/or Lactococcus lactis subsp cremoris.

In a particular embodiment, the strain of Lactobacillus sakei is used in combination with at least a starter culture. The skilled person in the art can readily select the appropriate cheese starter culture, depending on the type of fermented milk product to be produced.

Indeed, different types of cheese starter cultures are available. There are two basic types of starter cultures.

Mesophilic starters function at moderate temperatures and are used when curds will be warmed to a temperature not exceeding 39° C. The classic examples of cheeses made from such cultures are Cheddar and Gouda.

Thermophilic cultures, are employed when curds will be heated to a temperature as high as 52° C. Many Swiss and Italian cheeses use thermophilic cultures, as well as some other types of cheeses like Cheddar.

In a preferred embodiment the starter culture comprises lactic acid bacteria and preferably acidifying lactic acid bacteria as above defined and detailed.

In a preferred embodiment, the starter culture is the cheese starter culture Choozit™ Classic 111 FRO commercialized by Dupont-Danisco.

Therefore, the invention also relates to a bacterial composition comprising:

1. at least one strain of Lactobacillus sakei, as defined herein;
2. at least one other strain selected from the group consisting of:
a strain of Staphylococcus, such as a strain of Staphylococcus vitulinus, preferably the strain Staphylococcus vitulinus deposited at the CNCM by Danisco France SAS on 25 Apr. 2007 under the number CNCM I-3751, and
a strain of Brevibacterium, such as a strain of Brevibacterium casei, Brevibacterium linens or Brevibacterium aurantiacum; and
   3. at least one acidifying lactic acid bacteria, or a starter culture as defined above.

The bacteria used in the present invention may be provided in the form of a bacterial suspension, before or after freezing, or in the form of bacterial concentrates. Said bacterial concentrates may be thy, dried, lyophilized or frozen.

Typically, the bacteria used in the present invention can be stored at room temperature, at a temperature of about 4° C., about −20° C., about −80° C. or about −200° C. They can be associated with various excipients.

As used herein, the term “milk” has its general meaning in the art. It can be a milk of animal origin and/or vegetal origin.

A milk of animal origin refers to the white liquid produced by the mammary glands of mammals. The milk according to the present invention can be milk of any mammal origin such as cow's milk, goat's milk, sheep's milk, camel's milk, buffalo's milk or a combination thereof.

A milk of vegetal origin is any fermentable substance of vegetal origin, for example coming from soja, rice or malt seeds.

The expression “milk” also encompasses any reconstituted and/or recombined milks, e.g. a milk obtained by adding water to skim milk powder or to whole milk powder or a milk obtained by mixing together any milk components.

As used herein, the expression “fermented milk products”, also named cultured dairy foods, cultured dairy products, or cultured milk products, are i) either milk or a milk-based products that have been directly fermented with lactic acid bacteria such as Lactobacillus, Lactococcus, and Leuconostoc or ii) food products that have been produced with a process involving a step of milk fermentation with lactic acid bacteria such as Lactobacillus, Lactococcus, and Leuconostoc, and that have been subjected to further modifications such as a ripening step or that have been mixed with other food ingredients.

Some examples of “fermented milk products” are “fermented milks”, cheeses, milk-based drinks, yogurts, drinking yogurts. Preferably “fermented milk products” are “fermented milks” or cheeses. Preferably “fermented milk products” are cheeses.

As used herein, the term “cheese” has its general meaning in the art. It refers to the fermented milk product produced by coagulation of the milk protein casein. Typically, the milk is acidified and addition of the enzyme rennet causes coagulation. The solids are separated and pressed into final form. Some cheeses have molds on the rind or throughout. Most cheeses melt at cooking temperature.

Hundreds of types of cheese are produced. Their styles, textures and flavors depend on the origin of the milk (including the animal's diet), whether they have been pasteurized, the butterfat content, the type of microorganisms that are used, the processing, and the ripening (aging).

Cheeses can be classified according to their moisture content (expressed in percentage of water by total weight of the cheese): a cheese can be hard with a moisture content below 39%, semi-hard with a moisture content from 39% to 45% or soft with a moisture content above 45% preferably from 45 to 55%, preferably from 45 to 50%.

In a preferred embodiment, the cheese according to the invention is not a soft cheese, i.e. it has a moisture level of less than 45% of water per weight, preferably less than 40, even more preferably less than 38, 35, 30, 29, 28, 27, 26, 25, 20, 19, 18, 17, 16, 15, 14, 13, 12, 11, or 10% of water per weight.

Cheeses can also be classified according to their manufacturing process, and in particular to the type of ripening step employed:

Smear-Ripened Cheeses

Smear-ripened cheeses are washed-rind cheeses, which means that, during their production, they are repeatedly wiped or brushed with solution of bacteria or fungi (most commonly Brevibacterium, Debaryomyces and/or Geotrichum). This process allows producing a firm, flavorful rind around the cheese with a stronger flavour as the cheese matures.

In some cases, older cheeses are smeared on young cheeses to transfer the microorganisms. Many, but not all, of these have a distinctive pinkish or orange colouring to the exterior of the cheese. However, due to the regular “washing” steps, particularly in the early stages of production, this process is quite labour intensive compared to other methods of cheese production, and is more difficult to standardise leading to variability in cheeses quality.

Foil-Ripened Cheeses

Other types of cheese are ripened using the foil-ripening technology. According to this type of ripening, the cheese is covered with a film, such as a foil film (e.g. a plastic foil, an aluminium foil . . . ) and/or a wax, and placed at a temperature from 4° C. to 25° C., preferably from 9° C. to 17° C., preferably around 12° C., while it matures. This ripening process results in a cheese with no rind, having no or a limited growth of microorganisms on its surface and therefore a limited flavour in comparison to smear-ripened cheeses. The method according to this invention therefore allows solving this issue.

In one embodiment, the invention relates to a process for making a foil-ripened cheese comprising the steps of:
a) inoculating milk with at least one strain of Lactobacillus sakei and at least one strain of acidifying lactic acid bacteria.
b) fermenting for a period of time comprised between 2 and 24 hours at a temperature comprised between 28° C. and 55° C.
c) covering the fermented product obtained in step b) with a foil film
d) ripening for a period of time comprised between 2 weeks and 24 months at a temperature comprised between 4° C. and 25° C.

Generally a foil-ripened semi-hard cheese is ripened as a rindless cheese, with the young cheese being in packaged in foil after brining and then being ripened at a temperature of 4-14° C., preferably 9-11° C.

For Emmental, swiss cheeses and other hard foil-ripened cheeses, there is initially a pre-ripening step which occurred in a cold room comprising a temperature from 10 to 15° C. during 2-4 weeks, then in a warm room comprising a temperature from 15 to 25° C. during minimum 2 weeks, and at the end in the cold room comprising a temperature from 10 to 15° C. for several weeks/months.

When cheese is foil-ripened, little moisture is lost during the ripening, which is particularly economically advantageous. In addition, there is no or a limited amount of cutting losses when the foil-ripened cheeses are cut up into slices or bars as they have generally a rectangular shape.

The foil-ripened cheese is then coated, for example with thermoplastic films of Polymers of PE, PP, polyvinyl (PV): PV-OH or PVacetate. Permeable or non-permeable thermoplastic films can be used. Coating with a foodgrade wax can be used also.

In a preferred embodiment, the cheese according to the invention is therefore a foil-ripened cheese.

In another embodiment, the invention relates to a process for making a smear-ripened cheese comprising the steps of:

a) inoculating milk with at least one strain of Lactobacillus sakei and at least one strain of acidifying lactic acid bacteria.
b) fermenting for a period of time comprised between 2 and 24 hours at a temperature comprised between 28° C. and 55° C.
c) ripening for a period of time comprised between 2 weeks and 24 months at a temperature comprised between 4° C. and 25° C.

Advantageously, the strain of Lactobacillus sakei according to the invention is also useful for preserving fermented milk products against spoilage. Indeed, bacteria belonging to the Lactobacillus sakei specie have been shown to produce bacteriocins, which help inhibit the development of undesirable microorganisms such as Listeria monocytogenes.

In another aspect, the invention also relates to a fermented milk product, preferably a cheese, preferably a hard or semi-hard cheese, preferably a semi-hard cheese, even more preferably a semi-hard, foil-ripened cheese obtainable by the method as described above.

The invention also relates to a fermented milk product, preferably a cheese, preferably a hard or semi-hard cheese, preferably a semi-hard cheese, even more preferably a semi-hard, foil-ripened cheese, comprising at least one strain of Lactobacillus sakei.

Examples of hard or semi-hard cheeses according to the invention are Tilsit, Danbo, Hohlenkase, Raclette, Munster, Tomme, Tommette, Ossau-Iraty, Manchego, Gouda, Edam semi-hard cheeses and Cheddar, Cantal, Cheshire, Emmental, Gruyere, Beaufort, Parmesan, Romano hard cheeses.

In a particular embodiment the invention relates to a fermented milk product, such as a cheese, preferably a hard or semi-hard cheese, even more preferably a semi-hard cheese, even more preferably a semi-hard foil-ripened cheese, comprising at least one strain of Lactobacillus sakei which is selected from the group consisting of:
Lactobacillus sakei strain deposited at the CNCM by Danisco France SAS on 25 Apr. 2007 under the number CNCM I-3750;
Lactobacillus sakei strain deposited at the CNCM by Rhodia Food SAS on 23 May 2000 under the number CNCM I-2479;
and mixtures thereof.

Preferably Lactobacillus sakei is Lactobacillus sakei strain deposited at the CNCM by Danisco France SAS on 25 Apr. 2007 under the number CNCM I-3750.

In a preferred embodiment, the invention relates to a hard or semi-hard cheese comprising at least one strain of Lactobacillus sakei, wherein said hard or semi-hard cheese is selected from the group consisting of Tilsit, Danbo, Hohlenkase, Raclette, Munster, Tomme, Tommette, Ossau-Iraty, Manchego, Gouda, Edam semi-hard cheeses and Cheddar, Cantal, Cheshire, Emmental, Gruyere, Beaufort, Parmesan, Romano hard cheeses.

In a particular embodiment of a cheese as described herein (as obtained by the method of the invention or described as such), a cheese comprises or is obtained using, at least one strain of Lactobacillus sakei, and at least one strain of Staphylococcus such as Staphylococcus vitulinus and/or one strain of Brevibacterium such as Brevibacterium casei, Brevibacterium linens or/and Brevibacterium aurantiacum. In a particular embodiment, a cheese comprises or is obtained using, at least one strain of Lactobacillus sakei, at least one strain of Staphylococcus such as Staphylococcus vitulinus and/or one strain of Brevibacterium such as Brevibacterium casei, Brevibacterium linens or/and Brevibacterium aurantiacum, and at least one LAB, preferably at least one acidifying lactic acid bacteria, as described herein.

It is noteworthy that according to the teaching of the invention, said Lactobacillus sakei strain, and if present said at least one Staphylococcus strain and/or said at least one Brevibacterium strain, are inoculated in the milk, before fermentation and ripening, such that this/these strain(s) is/are found at least within the body or core of the cheese or exclusively within the body or core of the cheese, or in other words this/these strain(s) is/are not found at the surface of the cheese or are not found only at the surface of the cheese. In particular, this means that for smear-ripened cheeses, this/these strain(s) is/are found at least within the body or core of the smear-ripened cheese, or exclusively within the body or core of the smear-ripened cheese, so in other words this/these strain(s) is/are not found in the rind of this cheese or not only in the rind of this cheese.

Other features and advantages of the invention will emerge upon reading the following non-limiting examples.

### EXAMPLES

### Example 1

### 1.1 Introduction

Twelve combinations of strains were tested in association with Choozit™ Classic 111 FRO (in “VIP” Vat In Parallel model 200 g Gouda type cheeses. The VIP system is an equipment for cheese making. It enables to run 12 vats of milk simultaneously and so to test 12 combinations (or blends) of strains at the same time. The VIP has been especially adapted to Gouda technology. Accurate, reproducible and measurable process results are obtained with the VIP. Those cheeses and two standard cheeses with only Choozit™ Classic 111 FRO were ripened in foiled conditions at 12° C. during 6 weeks.

Choozit™ Classic 111 FRO is a starter culture comprising acidifying lactic acid bacteria. It comprises a mixture of several strains of Lactococcus lactis subsp lactis and Lactococcus lactis subsp cremoris.

To evaluate the aromatic potential of each combination in the VIP model cheeses, sensory analysis was performed by quantitative descriptive analysis.

### 1.2. Experimental Conditions

### 1.2.1. Composition of the Vats

Choozit™ Classic 111 FRO was used to inoculate the twelve cheeses vats, at 7 DCU for 100 L. Two control cheeses with only Choozit™ Classic 111 FRO were produced: Vat 1 and Vat 2.

Two industrial and deposited Lactobacillus sakei strains (CNCM I-3750 and CNCM I-2479) were studied either alone at an inoculation rate of 1.10E6 cfu/ml (Vat 3 and Vat 4 respectively) or in combination (Vat 8). They were also studied in association with a Brevibacterium casei strain (Vat 6 and Vat 7 respectively). This Brevibacterium casei was also tested alone in Vat 5.

Vat 10 was inoculated with a mixture of a Staphyloccus vitulinus strain (Staphyloccus vitulinus CNCM I-3751), a Lactobacillus paracasei strain, a Lactobacillus acidophilus strain (Lactobacillus acidophilus CNCM I-3784) and Lactobacillus sakei CNCM I-3750. The Vat 11 was inoculated with a mixture of a Staphyloccus vitulinus strain (Staphyloccus vitulinus CNCM I-3751) and Lactobacillus sakei CNCM I-3750. Finally, in the Vat 12, a mixture of a Lactobacillus paracasei strain and a Lactobacillus acidophilus strain (Lactobacillus acidophilus CNCM I-3784), was added.

### 1.2.2. Cheese Production and Ripening Conditions

Gouda cheeses were produced using the VIP equipment. This last one allows to make twelve 200 g cheeses using 2 L vats placed in parallel.

Blends were tested in association with an acidifying culture, Choozit™ Classic 111 FRO. Choozit™ Classic 111 FRO was added to production milk at nominal inoculation rate; and blends were inoculated according to formulation target (with semi-finished products). Two control cheeses were manufactured without added blend. After manufacturing, cheeses were wrapped in foil, and kept at +12° C. during 6 weeks.

Combinations of strains used to inoculate the cheese vats are summarized in Table 1.

TABLE 1
Combinations of strains used to inoculate the cheese vats

| | | | | | | | | | | Vat | Vat | Vat |
|---|---|---|---|---|---|---|---|---|---|---|---|---|
| | Vat 1 | Vat 2 | Vat 3 | Vat 4 | Vat 5 | Vat 6 | Vat 7 | Vat 8 | Vat 9 | 10 | 11 | 12 |
| Species | cfu/mL | | | | | | | | | | | |
| Staphylococcus vitulinus | | | | | | | | | | 1E+06 | 1E+06 | |
| CNCM I-3751 | | | | | | | | | | | | |
| Lactobacillus paracasei | | | | | | | | | | 1E+06 | | 1E+06 |
| Lactobacillus acidophilus | | | | | | | | | | 1E+06 | | 1E+06 |
| CNCM I-3784 | | | | | | | | | | | | |
| Lactobacillus sakei | | | 1E+06 | | | 1E+06 | | 1E+06 | 1E+06 | 1E+06 | 1E+06 | |
| CNCM I-3750 | | | | | | | | | | | | |
| Brevibacterium casei | | | | | 1E+06 | 1E+06 | 1E+06 | | 1E+06 | | | |
| Lactobacillus sakei | | | | 1E+06 | | | 1E+06 | 1E+06 | 1E+06 | | | |
| CNCM I-2479 | | | | | | | | | | | | |
| Choozit ™ Classic 111 | X | X | X | X | X | X | X | X | X | X | X | X |
| FRO at 7 DCU for 100L | | | | | | | | | | | | |

### 1.3. Sensory Analysis Method

The tasting session was organized with 10 well-trained assessors.

They assessed the intensity of 23 descriptors of appearance, texture and flavour using a seven points' scale. The samples were homogenous (same quantity, same presentation) and were coded with randomly selected 3 digit numbers. The statistical treatment of the data was done by one-way Analysis of Variance (ANOVA), which allows the assessment of significant differences (with α=5%) between the products for each descriptor.

### 1.4. Results

It has been verified that the two standard cheeses Vat 1 and Vat 2 organoleptic profiles are similar, with no significant difference (from ANOVA) for all the 23 descriptors.

The main significant difference between all those VIP cheeses was observable for Sulphur egg note, as described in Table 2 below.

The last column of the Table represents the groups (A, AB, ABC, BC and C) that were identified by one-way ANOVA mean comparison Newman-Keuls test. This statistical test enables to sort products having similar characteristic (i.e. no significant difference). The C group is composed by V1, V2, V5 and V12 and is the group which presents the least sulphur egg aroma scores. This group contains control VIP cheeses and cheeses with no Lactobacillus sakei strain. The A and AB groups are the ones with the most intense sulphur egg aroma. Those groups include cheeses inoculated with the Lactobacillus sakei CNCM I-3750 strain alone or in association. Finally, the ABC and BC groups are intermediate groups, which contain Lactobacillus sakei CNCM I-2479 strain.

It is clearly shown that the species Lactobacillus sakei plays a major role in the development of the sulphur aroma, particularly the sulphur egg aroma. Some variation in intensity can be also noticed between the two Lactobacillus sakei strains. Lactobacillus sakei CNCM I-3750 strain tends to produce more sulphur egg aroma than Lactobacillus sakei CNCM I-2479.

TABLE 2
Sulphur Egg aroma developed by different strain mixtures

| | | Sulphur | |
|---|---|---|---|
| | | Egg Aroma | |
| Vat | | (mean of 10 | ANOVA |
| number | Strain combination | assessors) | Groups |
| Vat 5 | Brevibacterium casei | 0.4 | C |
| Vat 2 | control | 0.5 | C |
| Vat 1 | control | 0.5 | C |
| Vat 12 | Lactobacillus paracasei + | 0.6 | C |
| | Lactobacillus acidophilus | | |
| | CNCM I-3784 | | |
| Vat 7 | Lactobacillus sakei | 1.1 | BC |
| | CNCM I-2479 + | | |
| | Brevibacterium casei | | |
| Vat 4 | Lactobacillus sakei | 1.9 | ABC |
| | CNCM I-2479 | | |
| Vat 8 | Lactobacillus sakei CNCM I-3750 + | 2.3 | AB |
| | Lactobacillus sakei CNCM I-2479 | | |
| Vat 6 | Lactobacillus sakei CNCM I-3750 + | 2.6 | A |
| | Brevibacterium casei | | |
| Vat 9 | Lactobacillus sakei CNCM I-3750 + | 2.6 | A |
| | Lactobacillus sakei CNCM I-2479 + | | |
| | Brevibacterium casei | | |
| Vat 10 | Lactobacillus sakei CNCM I-3750 + | 2.7 | A |
| | Staphylococcus vitulinus | | |
| | CNCM I-3751 + | | |
| | Lactobacillus paracasei + | | |
| | Lactobacillus acidophilus | | |
| | CNCM I-3784 | | |
| Vat 3 | Lactobacillus sakei CNCM I-3750 | 3.0 | A |
| Vat 11 | Lactobacillus sakei CNCM I-3750 + | 3.2 | A |
| | Staphylococcus vitulinus | | |
| | CNCM I-3751 | | |

### Example 2

### 2.1. Composition of the Cheeses

Two Gouda cheeses were produced using the VIP equipment.

Choozit™ Classic 111 FRO was used to inoculate the two cheeses VIP vats, at 7 DCU for 100 L. The control cheeses containing only Choozit™ Classic 111 FRO was produced in vat 21.

Deposited Lactobacillus sakei strain CNCM I-3750 and Staphylococcus vitulinus CNCM I-2479 were studied at an inoculation rate of 1.10E6 cfu/ml in combination in vat 22. After manufacturing, both cheeses were wrapped in foil, and kept 2 weeks at +12° C., then 2 weeks at +9° C., and finally 3 weeks at +12° C. (total of 7 weeks).

### 2.2. Sensory Analysis Method

The tasting session was organized with 12 well-trained assessors.

They assessed the intensity of 23 descriptors of appearance, texture and flavour using a seven points' scale. The samples were homogenous (same quantity, same presentation) and were coded with randomly selected 3 digit numbers. The statistical treatment of the data was done by one-way Analysis of Variance (ANOVA), which allows the assessment of significant differences (with α=5%) between the products for each descriptor.

### 2.3. Chromatography Analysis Method

The sulphur volatile compounds e.g. hydrogen sulphide, methanethiol and dimethylsulphide were determined by a Gas Chromatography coupled with a Mass Spectrometer detector.

The SPME (Solid Phase Micro-Extraction) technique was used to extract the sulphur compounds from the cheeses. The volatile compounds were then injected in the Gas Chromatography, separated in a capillary column, and were detected by the Mass Spectrometer. The method was calibrated for each of the three compounds.

### 2.4. Results

A significant difference between the two VIP cheeses was observable for Sulphur egg note. Thus, the Vat 22 had significantly more Sulphur Egg aroma than the Control Vat 21.

| | | Sulphur | |
|---|---|---|---|
| | | Egg Aroma | |
| Vat | | (mean of 12 | ANOVA |
| number | Strain combination | assessors) | Groups |
| Vat 21 | Control | 0.75 | B |
| Vat 22 | Lactobacillus sakei | 1.92 | A |
| | CNCM I-3750 + | | |
| | Staphylococcus vitulinus | | |
| | CNCM I-3751 | | |

The Vat 22 had also quantitatively more sulphur volatile compounds than the Control Vat 21: The hydrogen sulfide content was higher in Vat 22 (16.9-fold increase), so as for the methanethiol and dimethylsulfide, as compared to Vat 21.

| | | hydrogen | methane- | Dimethyl- |
|---|---|---|---|---|
| Vat | | sulfide | thiol | sulfide |
| number | Strain combination | (μg/kg) | (μg/kg) | (μg/kg) |
| Vat 21 | Control | 6.3 | 5.7 | 3.7 |
| Vat 22 | Lactobacillus sakei | 107.0 | 8.3 | 6.7 |
| | CNCM I-3750 + | | | |
| | Staphylococcus vitulinus | | | |
| | CNCM I-3751 | | | |

### Example 3

### 3.1. Composition of the Cheeses

Two, semi-hard, Tilsit type, cheeses were produced.

One control cheese named 31 was produced with a mesophilic acidifying starter (different from the Choozit™ Classic 111 FRO). A trial cheese named 32 with the same acidifying starter added with both deposited Lactobacillus sakei strain CNCM I-3750 and Staphylococcus vitulinus CNCM I-2479 (each at an inoculation rate of 5.10E6 cfu/ml) was produced. After manufacturing, both cheeses were wrapped in foil, and kept 3 months at +12° C.

### 3.2. Sensory Analysis Method

The tasting session was organized with 14 well-trained assessors.

They assessed the intensity of 23 descriptors of appearance, texture and flavour using a seven points' scale. The samples were homogenous (same quantity, same presentation) and were coded with randomly selected 3 digit numbers. The statistical treatment of the data was done by one-way Analysis of Variance (ANOVA), which allows the assessment of significant differences (with α=5%) between the products for each descriptor.

### 3.3. Chromatography Analysis Method

The sulphur volatile compounds e.g. hydrogen sulphide, methanethiol and dimethylsulphide were determined by a Gas Chromatography coupled with a Mass Spectrometer detector.

The SPME (Solid Phase Micro-Extraction) technique was used to extract the sulphur compounds from the cheeses. The volatile compounds were then injected in the Gas Chromatography, separated in a capillary column, and were detected by the Mass Spectrometer. The method was calibrated for each of the three compounds.

### 3.4. Results

A significant difference between the two Tilsit type cheeses was observable for Sulphur egg note. The control cheese 31 had significantly less Sulphur Egg aroma than the trial cheese 32 with the combination of strains.

| | | Sulphur | |
|---|---|---|---|
| | | Egg Aroma | |
| Product | | (mean of 14 | ANOVA |
| names | Strain combination | assessors) | Groups |
| Control | Control | 0.76 | B |
| cheese 31 | | | |
| Trial | Lactobacillus sakei | 2.32 | A |
| Cheese 32 | CNCM I-3750 + | | |
| | Staphylococcus vitulinus | | |
| | CNCM I-3751 | | |

The trial cheese 32 had quantitatively more sulphur volatile compounds than the control cheese 31. The hydrogen sulfide content was higher in trial cheese 32 (3.9-fold increase), so as for the methanethiol and dimethylsulfide, as compared to cheese 31

| | | hydrogen | methane- | Dimethyl- |
|---|---|---|---|---|
| Vat | | sulfide | thiol | sulfide |
| number | Strain combination | (μg/kg) | (μg/kg) | (μg/kg) |
| Control | Control | 75.5 | 6.2 | 2.8 |
| cheese 31 | | | | |
| Trial | Lactobacillus sakei | 300.0 | 10.0 | 3.5 |
| Cheese 32 | CNCM I-3750 + | | | |
| | Staphylococcus vitulinus | | | |
| | CNCM I-3751 | | | |

### Example 4

### 4.1. Composition of the Cheeses

Two hard Cheddar type cheeses are produced. One control cheese named 41 is produced with a combination of mesophilic starer and a thermophilic starter. A trial cheese named 42 with the same acidifying starter added with both deposited Lactobacillus sakei strain CNCM I-3750 and Staphylococcus vitulinus CNCM I-2479 (each at an inoculation rate of 5.10E6 cfu/ml) is produced. After manufacturing, both cheeses are wrapped in foil, and kept 3 months at +12° C.

### 4.2. Sensory Analysis Method

The tasting session is organized with well-trained assessors. They assess the intensity of 20 descriptors for the Cheddar cheese sensory evaluation, texture and flavour, using a seven points' scale. The samples are homogenous (same quantity, same presentation) and are coded with randomly selected 3 digit numbers. The statistical treatment of the data is done by one-way Analysis of Variance (ANOVA), which allows the assessment of significant differences (with α=5%) between the products for each descriptor.

### 4.3. Chromatography Analysis Method

The sulphur volatile compounds e.g. hydrogen sulphide, methanethiol and dimethylsulphide are determined by a Gas Chromatography coupled with a Mass Spectrometer detector. The SPME (Solid Phase Micro-Extraction) technique is used to extract the sulphur compounds from the cheeses. The volatile compounds are then injected in the Gas Chromatography, separated in a capillary column, and are detected by the Mass Spectrometer. The method is calibrated for each of the three compounds.

### Example 5

### 5.1. Composition of the Cheeses

Two Munster (smear-ripened) cheeses are produced. One control cheese named 51 is produced with a mesophilic acidifying starter. A trial cheese named 52 with the same acidifying starter added with both deposited Lactobacillus sakei strain CNCM I-3750 and Staphylococcus vitulinus CNCM I-2479 (each at an inoculation rate of 5.10E6 cfu/ml) is produced. After manufacturing, both cheeses are kept 2 weeks at +12° C. minimum.

### 5.2. Sensory Analysis Method

The tasting session is organized with well-trained assessors. They assess the intensity of 23 descriptors of appearance, texture and flavour using a seven points' scale. The samples are homogenous (same quantity, same presentation) and are coded with randomly selected 3 digit numbers. The statistical treatment of the data is done by one-way Analysis of Variance (ANOVA), which allows the assessment of significant differences (with α=5%) between the products for each descriptor.

### 5.3. Chromatography Analysis Method

The sulphur volatile compounds e.g. hydrogen sulphide, methanethiol and dimethylsulphide are determined by a Gas Chromatography coupled with a Mass Spectrometer detector. The SPME (Solid Phase Micro-Extraction) technique is used to extract the sulphur compounds from the cheeses. The volatile compounds are then injected in the Gas Chromatography, separated in a capillary column, and are detected by the Mass Spectrometer. The method is calibrated for each of the three compounds.

1-2. (canceled)

3. A method for producing volatile sulphur compounds in fermented milk products, comprising the step of inoculating milk with at least one strain of Lactobacillus sakei.

4. A method for making a fermented milk product having a sulphur aroma comprising the step of inoculating milk with at least one strain of Lactobacillus sakei.

5. The method according to claim 4, wherein the strain of Lactobacillus sakei is selected from the group consisting of:
Lactobacillus sakei strain deposited at the CNCM by Danisco France SAS on 25 Apr. 2007 under the number CNCM I-3750;
Lactobacillus sakei strain deposited at the CNCM by Rhodia Food SAS on 23 May 2000 under the number CNCM I-2479;
and mixtures thereof.

6. The method according to any of the above claims claim 4, wherein said strain of Lactobacillus sakei is used in combination with one or several other microorganism(s).

7. The method according to any of the above claims claim 6, wherein said other microorganism(s) comprise(s) a strain of Staphylococcus, such as a strain of Staphylococcus vitulinus, and/or a strain of Brevibacterium, such as a strain Brevibacterium casei, Brevibacterium linens or Brevibacterium aurantiacum.

8. (canceled)

9. The method according to any of the above claims claim 6, wherein said other microorganism(s) comprise at least one strain of acidifying lactic acid bacterium.

10. The method according to any of the above claims claim 9, wherein said acidifying lactic bacterium is a strain belonging to the specie Lactococcus lactis, preferably Lactococcus lactis subsp lactis and/or Lactococcus lactis subsp cremoris.

11. The method according to any of the above claims claim 10, wherein strain of Lactobacillus sakei is used in combination with a starter culture, preferably the Choozit™ Classic 111 FRO starter culture.

12. (canceled)

13. The method according to any of the above claims claim 4, wherein the fermented milk product is a cheese, preferably a semi-hard cheese, even more preferably a semi-hard, foil-ripened cheese.

14. A fermented milk product, preferably cheese even more preferably a semi-hard cheese, even more preferably a semi-hard, foil-ripened cheese obtainable by the method as described above according to claim 4.

15. A fermented milk product, preferably cheese, preferably a semi-hard cheese, even more preferably a semi-hard, foil-ripened cheese, comprising at least one strain of Lactobacillus sakei.

16. The fermented milk product according to claim 15, which is a cheese wherein the strain of Lactobacillus sakei is selected from the group consisting of:
Lactobacillus sakei strain deposited at the CNCM by Danisco France SAS on 25 Apr. 2007 under the number CNCM I-3750;
Lactobacillus sakei strain deposited at the CNCM by Rhodia Food SAS on 23 May 2000 under the number CNCM I-2479;
and mixtures thereof.

17. A bacterial composition comprising at least one strain of Lactobacillus sakei and at least one other strain selected from the group consisting of:
a strain of Staphylococcus vitulinus, preferably the strain Staphylococcus vitulinus deposited at the CNCM by Danisco France SAS on 25 Apr. 2007 under the number CNCM I-3751,
a strain of Brevibacterium, such as a strain Brevibacterium casei, Brevibacterium linens or Brevibacterium aurantiacum

18. The bacterial composition according to claim 17, wherein the at least one strain of Lactobacillus sakei is selected from the group consisting of:
Lactobacillus sakei strain deposited at the CNCM by Danisco France SAS on 25 Apr. 2007 under the number CNCM I-3750;
Lactobacillus sakei strain deposited at the CNCM by Rhodia Food SAS on 23 May 2000 under the number CNCM I-2479;
and mixtures thereof.

19. The method according to claim 6, wherein said other microorganism(s) comprise(s) a strain of Staphylococcus, such as a strain of Staphylococcus vitulinus, and/or a strain of Brevibacterium, such as a strain Brevibacterium casei, Brevibacterium linens or Brevibacterium aurantiacum, and comprise at least one strain of acidifying lactic acid bacterium.

20. The method according to claim 7, wherein said other microorganism(s) comprise at least one strain of acidifying lactic acid bacterium.

21. The method according to any of the above claims claim 9, wherein the fermented milk product is a cheese, preferably a semi-hard cheese, even more preferably a semi-hard, foil-ripened cheese.
